(19) United States
(12) Patent Application Publication
(10) Pub. No.: US 2026/0361915 A1
(43) Pub. Date: Nov. 12, 2026

(54) METHOD AND APPARATUS FOR VIDEO CODING

(71) Applicant: Nokia Technologies Oy, Espoo (FI)

(72) Inventors: Daniele MARI, Antwerp (BE); Patrice RONDAO ALFACE, Antwerp (BE)

(21) Appl. No.: 19/535,450

(22) Filed: Feb. 10, 2026

Related U.S. Application Data
(60) Provisional application No. 63/757,258, filed on Feb. 11, 2025.

(51) Int. Cl. H04N 19/597; H04N 19/70

(52) U.S. Cl. CPC H04N 19/597; H04N 19/70

(57) ABSTRACT

The embodiments concern a method for encoding and a method for decoding, and the apparatuses for implementing the methods. The method for encoding comprises receiving a set of representation primitives as input, the set of representation primitives representing volumetric content; extracting scene information; encoding the scene information to a bitstream; predicting a set of primitives based on the scene information; and encoding metadata concerning the prediction and the scene information to the bitstream. The embodiments also concern technical equipment for implementing the methods.

### TECHNICAL FIELD

The present solution relates generally to coding of volumetric video.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video codec comprises an encoder and a decoder. The encoder transforms an input video into a compressed representation suited for storage and/or transmission. The decoder decompresses the compressed video representation back into a viewable form. During encoding, the encoder may discard some information in the original video sequence to be able to represent the video in a more compact form (that is, at lower bitrate).

Term “volumetric video” refers to a technique that captures three-dimensional space to be rendered either on flat screens, but also on three-dimensional displays or virtually with dedicated virtual display systems. Visual Volumetric Video-based coding (V3C) is a standard for coding volumetric video.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding comprising at least one processor and at least one memory, said at least one memory stored with code thereon, which when executed by said at least one processor, causes the apparatus to: receive a set of representation primitives as input, the set of representation primitives representing volumetric content; extract scene information; encode the scene information to a bitstream; predict a set of primitives based on the scene information; and encode metadata concerning the prediction and the scene information to the bitstream

According to a second aspect, there is provided a method for encoding comprising receiving a set of representation primitives as input, the set of representation primitives representing volumetric content; extracting scene information; encoding the scene information to a bitstream; predicting a set of primitives based on the scene information; and encoding metadata concerning the prediction and the scene information to the bitstream

According to a third aspect, there is provided an apparatus for encoding comprising means for receiving a set of representation primitives as input, the set of representation primitives representing volumetric content; means for extracting scene information; means for encoding the scene information to a bitstream; means for predicting a set of primitives based on the scene information; and means for encoding metadata concerning the prediction and the scene information to the bitstream

According to a fourth aspect, there is provided computer program product for encoding comprising computer program code configured to, when executed on at least one processor, cause an apparatus or a system to receive a set of representation primitives as input, the set of representation primitives representing volumetric content; extract scene information; encode the scene information to a bitstream; predict a set of primitives based on the scene information; and encode metadata concerning the prediction and the scene information to the bitstream

According to an embodiment for any of the previous aspects, a representation primitive is one of the following: a Gaussian splat, a spherical point, an ellipsoid, a billboard or any other primitive suitable for being used in rendering volumetric content.

According to an embodiment for any of the previous aspects and/or embodiment, the extracted scene information is independent from instances of the representation primitives.

According to an embodiment for any of the previous aspects and/or embodiments, the scene information is extracted using one of the following: neural autoencoder, hierarchical aggregation, or probabilistic hierarchy, or using some other suitable extraction method.

According to an embodiment for any of the previous aspects and/or embodiments, the set of primitives is predicted by means of a neural network model or by sampling the set of primitives from their parent primitive.

According to an embodiment for any of the previous aspects and/or embodiments, the predicted set of primitives is refined, and to encode metadata concerning the refinement to the bitstream.

According to an embodiment for any of the previous aspects and/or embodiments, the refinement results in refined primitives, wherein the metadata concerning the refinement comprises residuals between the refined primitives and the predicted primitives.

According to an embodiment for any of the previous aspects and/or embodiments, camera parameters are used for refining the predicted set of primitives.

According to an embodiment for any of the previous aspects and/or embodiments, an identifier for a type of the representation primitive is encoded to metadata.

According to an embodiment for any of the previous aspects and/or embodiments, an identifier for an attribute type of the representation primitive is encoded to metadata.

According to an embodiment for any of the previous aspects and/or embodiments, an identifier for a scene information extractor is encoded to metadata.

According to an embodiment for any of the previous aspects and/or embodiments, an identifier for a residual type is encoded to metadata.

According to an embodiment for any of the previous aspects and/or embodiments, the computer program product is embodied on a non-transitory computer readable medium.

According to a fifth aspect, there is provided an apparatus for decoding comprising at least one processor and at least one memory, said at least one memory stored with code thereon, which when executed by said at least one processor, causes the apparatus to: receive an encoded bitstream; decode metadata from the encoded bitstream, wherein metadata concerns at least a prediction and scene information; decode scene information from the encoded bitstream; predict a set of primitives using the decoded scene information and metadata; and generate a set of representation primitives based on the set of predicted primitives.

According to a sixth aspect, there is provided a method for decoding comprising receiving an encoded bitstream; decoding metadata from the encoded bitstream, wherein metadata concerns at least a prediction and scene information; decoding scene information from the encoded bitstream; predicting a set of primitives using the decoded scene information and metadata; and generating a set of representation primitives based on the set of predicted primitives.

According to a seventh aspect, there is provided an apparatus comprising at least means for receiving an encoded bitstream; means for decoding metadata from the encoded bitstream, wherein metadata concerns at least a prediction and scene information; means for decoding scene information from the encoded bitstream; means for predicting a set of primitives using the decoded scene information and metadata; and means for generating a set of representation primitives based on the set of predicted primitives.

According to an eighth aspect, there is provided computer program product for decoding comprising computer program code configured to, when executed on at least one processor, cause an apparatus or a system to receive an encoded bitstream; decode metadata from the encoded bitstream, wherein metadata concerns at least a prediction and scene information; decode scene information from the encoded bitstream; predict a set of primitives using the decoded scene information and metadata; and generate a set of representation primitives based on the set of predicted primitives.

According to an embodiment for any of the previous aspects, refinement information is decoded from the metadata and the predicted set of primitives are refined based on the refinement information.

According to an embodiment for any of the previous aspects and/or embodiment, the refinement information comprises residuals, whereupon the apparatus is caused to integrate the residuals to the predicted primitives.

According to an embodiment for any of the previous aspects and/or embodiments, an identifier for a type of the representation primitive is decoded from metadata.

According to an embodiment for any of the previous aspects and/or embodiments, an identifier for an attribute type of the representation primitive is decoded from metadata.

According to an embodiment for any of the previous aspects and/or embodiments, an identifier for a scene information extractor is decoded from metadata.

According to an embodiment for any of the previous aspects and/or embodiments, an identifier for a residual type is decoded from metadata.

According to an embodiment for any of the previous aspects and/or embodiments, the computer program product is embodied on a non-transitory computer readable medium.

### BRIEF DESCRIPTION OF THE DRAWINGS

For a more complete understanding of example embodiments of the present invention, reference is now made to the following descriptions taken in connection with the accompanying drawings in which:

FIG. 1 shows an example of a Gaussian splat;

FIG. 2 shows an example of an encoder according to an embodiment;

FIG. 3 shows an example of a decoder according to an embodiment;

FIG. 4 shows an example of sample gaussians to uniformly cover the parent;

FIGS. 5a-5d show different modules of an encoder according to an embodiment;

FIGS. 6a-6c show different modules of a decoder according to an embodiment;

FIG. 8 is a flow diagram showing a method for decoding according to an embodiment;

FIG. 9 shows an apparatus according to an embodiment; and

FIG. 10 shows a schematic diagram of an example multimedia communication system within which various embodiments may be implemented.

### DETAILED DESCRIPTON OF THE DRAWINGS

The following description and drawings are illustrative and are not to be construed as unnecessarily limiting. The specific details are provided for a thorough understanding of the disclosure. However, in certain instances, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure.

The present embodiments are targeted coding of volumetric video and in particular to coding of representation primitives relating to the volumetric video by using instance-agnostic representation of the scene. However, before describing the embodiments further, a brief reference to concept of volumetric video is given.

Volumetric video data represents a three-dimensional (3D) scene or object, and can be used as input for AR (Augmented Reality), VR (Virtual Reality), and MR (Mixed Reality) applications. Such data describes geometry (shape, size, position in 3D space) and respective attributes (e.g., color, opacity, reflectance, etc.), and any possible temporal transformations of the geometry and attributes at given time instances (like frames in two-dimensional (2D) video). Volumetric video can be generated from 3D models, also referred to as volumetric visual objects, i.e., CGI (Computer Generated Imagery), or captured from real-world scenes using a variety of capture solutions, e.g., multi-camera, laser scan, combination of video and dedicated depth sensors, and more. Also, a combination of CGI and real-world data is possible. Examples of representation formats for volumetric data comprise triangle meshes, point clouds, or voxels. Temporal information about the scene can be included in the form of individual capture instances, i.e., “frames” in 2D video, or other means, e.g., position of an object as a function of time.

Because volumetric video describes a 3D scene (or object), such data can be viewed from any viewpoint. Therefore, volumetric video is an important format for any AR, VR or MR applications, especially for providing 6DOF (Six Degrees Of Freedom) viewing capabilities.

Increasing computational resources and advances in 3D data acquisition devices have enabled reconstruction of highly detailed volumetric video representations of natural scenes. Infrared, lasers, time-of-flight, and structured light are examples of devices that can be used to construct 3D video data. Representation of the 3D data depends on how the 3D data is used. Dense Voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding, this 3D data as set of texture and depth map as is the case in the multi-view plus depth. Closely related to the techniques used in multi-view plus depth is the use of elevation maps, and multi-level surface maps.

### Volumetric Content

There are many ways to capture and represent a volumetric scene. The format used to capture and represent the volumetric scene depends on the processing to be performed on the scene, and the target application using the scene. Some examples are listed in the following:
A volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA (Red, Green, Blue, Alpha) value, or normal vectors)
A volumetric frame can be represented as images, with or without depth, captured from multiple viewpoints in 3D space. In other words, it can be represented by one or more view frames (where a view is a projection of a volumetric scene on to a plane (the camera plane) using a real or virtual camera with known/computed extrinsics and intrinsics). Each view may be represented by a number of components (e.g. geometry, color, transparency, and occupancy picture), which may be part of the geometry picture or represented separately.
A volumetric frame can be represented as a mesh. Mesh is a collection of points, called vertices, and connectivity information between vertices, called edges. Vertices along with edges form faces. The combination of vertices, edges and faces can uniquely approximate shapes of objects.
Volumetric frame can be represented as a various N-dimensional primitives, cubes (voxels), spheres, ellipsoids, planes, convex hulls, etc. with various geometric and visual/appearance attributes. Example of one widely used such primitives could be 3D Gaussians.
Volumetric frame can be represented as an implicit neural radiance field such as the Neural Radiance Fields (NeRFs) representation. A NeRF is a representation of a 3D scene that is parametrized by a deep neural network (DNN). The network predicts a volume density and view-dependent emitted radiance given the spatial location (x, y, z) and viewing direction, e.g., in Euler angles (θ, Φ) of the camera. Volume rendering techniques can produce an image by sampling points along rays intercepted by the camera projection model.

Yet further, a volumetric frame can be represented as a radiance field such as the Gaussian Splatting (a.k.a., 3DGS (Three-Dimensional Gaussian Splatting), 4DGS (Four-Dimensional Gaussian Splatting), Gaussian Splat) representation. This representation can be seen as a point cloud representation with additional attributes that model the geometry and appearance of the scene in the close neighborhood of a position (x, y, z). Rendering of radiance fields represented as Gaussian splats and other variants using modified versions of the attributes may be performed by simple and fast rasterization or more accurate volume rendering using ray tracing.

Depending on the capture, a volumetric frame can provide viewers the ability to navigate a scene with six degrees of freedom (6DOF), i.e., both translational and rotational movement of their viewing pose (which includes yaw, pitch, and role). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

### Point Cloud

A point cloud is a data structure that can be used to represent a three-dimensional scene. Point clouds consist of a set of points in a coordinate system. Each point is defined by its three coordinates and may be associated with zero or more attributes. Attributes can have different types and are used to describe the properties of a point, such as its color or reflectance. Point clouds are created by sensors such as Lidar (“light detection and ranging”) or Radar (“radio detection and ranging”) sensors or by depth cameras or by multi-camera setups or by ultrasound devices or by other distance sensing devices or combinations one or more of the above and, optionally, other devices. Many use-case scenarios exist for point clouds. An example of a use case is a vehicle that uses one or multiple sensors to scan its environment to create a point cloud describing its surroundings. The point clouds can then be used for further processing, e.g., for creating a virtual mapping of the environment, for autonomous driving use cases, or for teleoperation. In some cases, further processing has to be done on a device different from the one that captured the point cloud. In those cases, point clouds or sequences of point clouds have to be transmitted over a network. Due to the large amount of data that point cloud sequences produce, transmitting the data in real-time is challenging. In addition to the use of efficient codecs to reduce the data rate, it may be beneficial to lower the bandwidth requirements by prioritizing certain parts of a point cloud and allowing other parts to be removed from the point cloud before transmission. Moreover, transmission channels (such as wireless networks, packet networks, or other potentially unreliable channels) may not deliver all point cloud data intact, in which case, possibly selective, repair mechanisms may be beneficial.

### Geometry-Based Point Cloud Compression (G-PCC)

G-PCC is an encoding mechanism defined by the Moving Picture Experts Group (MPEG) to reduce the size of a point cloud. G-PCC encodes point clouds with a number of tools that are especially efficient for sparse point cloud data. The geometry of the point cloud is first encoded as an octree and attributes are coded depending on the geometry. In other words, the attribute coding relies on reconstructed geometry data that can be reproduced exactly at encoder and decoder to avoid coding drifts and errors for attributes. Different tools are available after octree decomposition within G-PCC specifications, such as “trisoup” that consists in a surface approximation based on a set of triangles defined on octree leaves, and such as predictive occupancy octree coding. Attributes may be transferred from the original point cloud to the reconstructed geometry. Attributes may be coded with a Level of Detail (LoD)-based approach combined with a predictive transform and optionally a Lifting Transform. As an alternative approach to LoDs, a Region-Adaptive Hierarchical Transform (RAHT) has provided interesting inter prediction compression performances. In the emerging G-PCC edition 2, these tools have been extended and complemented, offering more access granularity to LoDs, adaptive quantization per LoD, cross-attribute prediction within a LoD, LoD attribute slices, enhanced coding of DC and AC components of RAHT, and overall, a better point cloud inter prediction performance.

### Visual Volumetric Video-Base Coding (V3C)—ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MPEG Immersive Video (MIV) (ISO/IEC 23090-12). MIV and V-PCC use number of V3C syntax elements with a slightly modified semantics. An example on how the generic syntax element can be differently interpreted by the application is pdu_projection_id.
In case of V-PCC the syntax element, pdu_projection_id specifies the index of the projection plane for the patch. There can be 6 or 18 projection planes in V-PCC, and they are implicit, i.e. pre-determined.
In case of MIV, pdu_projection_id corresponds to a view identifier (ID), i.e., it identifies which view the patch originates from. View IDs and their related information are explicitly provided in MIV view parameters list and may be tailored for each content.

MPEG 3DG (ISO SC29 WG7) group works on a third application of V3C, i.e., the mesh compression. It is envisaged that mesh coding will re-use V3C syntax as much as possible and can also slightly modify the semantics.

To differentiate between applications of V3C bitstream, that allows a client to properly interpret the decoded data, V3C may use the ptl_profile_toolset_idc parameter.

### Gaussian Splats

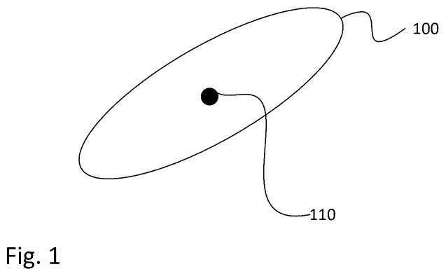

Gaussian splatting is a rendering technique to create three-dimensional scenes using plurality of translucent ellipsoids, called “Gaussian splat”. These splats are used to represent a scene. Each splat carries more information than for example a point in a point cloud. Gaussian splat is defined by its position, color, size and transparency, whereas a point of a point cloud carries information on its position and color. Gaussian splats are generated by using multiple frames representing a same object from different angles. The multiple frames are analyzed to create a preliminary 3D point cloud of the scene. Each point in this 3D point cloud is converted into Gaussian splat, i.e., a point is expanded into an ellipsoid with the specific properties. This is done by extending the point's value using a Gaussian curve. The center of the Gaussian splat has the highest value, and the values will attenuate when moving away from the center. FIG. 1 illustrates a Gaussian splat 100. The position information is the one of its center highlighted by a circle 110. The size and orientation of the shape of the splat is determined by the scale and rotation. The color, transparency and reflectivity are defined by the spherical harmonics and opacity.

The attributes of the Gaussian Splat are:
Attributes:
   Position (x,y,z);
   Scale (sx,sy,sz); i.e., non-uniform scale factor of the Gaussian splat;
   Rotation (rx,ry,rz) or (qx,qy,qz,qw); i.e., the rotation of the Gaussian splat with respect to world coordinates, the rotation is expressed by Euler angles or quaternions;
Normal (nx, ny, nz); i.e., the normal vector of the Gaussian splat
   Opacity (alpha), i.e., a factor that indicates the transparency of the Gaussian splat
   Color (r,g,b), i.e., the primary color of the Gaussian splat
Spherical harmonics (e.g. SH[0:48]), i.e., the reflectance of the Gaussian splat expressed in spherical harmonics. Sometimes color is represented by the DC component of spherical harmonics, and spherical harmonics contain 45 non-DC components. Spherical harmonics can be seen as DCT basis functions defined on the sphere.

The rendering function for a Gaussian splat is as follows:

$${g}_{i} ( p ) = αexp ( - \frac{1}{2} ( p - {μ}_{i} ) {\sum }_{i}^{- 1} ( p - {μ}_{i} ) )$$

where p is the point in the Gaussian splat; μ is the center of the Gaussian splat, α is the opacity factor, Σ is the covariance matrix and is equal to:

Σ=RSS^{T}R^{T}
where R is a 3×3 rotation matrix expressed with 4 quaternions and S is a diagonal scaling matrix with 3 parameters for scale.

When comparing Spherical harmonics with DCT basis functions, it has been realized that similarly to DCT that enables low to high frequency variations on the horizontal and vertical axis of an image, increasing order of spherical harmonics shows increasing frequency variations in vertical and horizontal directions on the sphere. Some approaches achieve a fast estimation of the Spherical harmonics transform and inverse transform by relying on the FFT.

Other variants of radiance fields representations include:
Spherical point clouds, which are similar to Gaussian splats except that the shape is spherical, i.e., there is only one scale factor and there is no rotation attribute data and no falloff due to the gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats, but the rendering equation is defined on a rectangle.
2DGS or surfels, similar to Gaussian splats but where the smallest scale is set to zero and a normal is defined. These may be defined on surfaces in the tangent space. The rendering equation is the same as for Gaussian splats.
Gaussian splats with neural appearance attributes, where view dependent appearance is represented by latent variables. The rendering equation requires a Multi-Layer Perceptron (MLP) to decode the latent appearance.

Some variants of Gaussian splats do not explicitly encode a unique center position with extra attributes, but do not prevent from coding or deriving such a center position. For example, billboards of Gaussian Textures describe a rectangular tile on which the Gaussian splat representation is defined instead of a single central point. Another example is 3D Convex Splatting (3DCS) that encode a polygonal shape containing N points without encoding any central position. Nevertheless, the appearance attributes are similar to 3DGS as well as the rendering and learning strategy used to model those from input camera views.

### Coding of Gaussian Splats

A few examples of coding formats that are available for Gaussian splat coding are as follows.
SPZ, i.e., .spz file format for static Gaussian splats;
an extension of G-PCC.

A short description of these is given next.

The .spz format is a gzipped stream of data consisting of a 16-byte header followed by the gaussian data. This data is organized by attribute in the following order: positions, scales, rotations, alphas, colors, spherical harmonics.

The header is as follows in little-endian.

| PackedGaussianHearder ( ) | |
|---|---|
| uint32_t | magic; |
| uint32_t | version; |
| uint32_t | numPoints; |
| uint8_t | shDegree; |
| uint8_t | fractionalBits; |
| uint8_t | flags; |
| uint8_t | reserved; |

Values are specified as follows:
magic: 0x5053474e
   version: 2
   numPoints: number of encoded gaussians
   shDegree: The degree of spherical harmonics. This must be between 0 and 3 (inclusive).
   fractionalBits: number of bits used to store the fractional part of coordinates in the fixed-point encoding.
   flags: bit field containing flags.
   0x1: whether the splat was trained with antialiasing.
   reserved: Reserved for future use. Must be 0.

In .spz format Positions are represented as (x, y, z) coordinates, each as a 24-bit fixed point signed integer. The number of fractional bits is determined by the fractionalBits field in the header.

Scales are represented as (x, y, z) components, each represented as an 8-bit log-encoded integer.

Rotations are represented as the (x, y, z) components of the normalized rotation quaternion. The w component can be derived from the others and is not stored. Each component is encoded as an 8-bit signed integer.

Alphas are represented as 8-bit unsigned integers.

Colors are stored as (r, g, b) values, where each color component is represented as an unsigned 8-bit integer.

Depending on the degree of spherical harmonics for the splat, this can contain 0 (for degree 0), 9 (for degree 1), 24 (for degree 2), or 45 (for degree 3) coefficients per gaussian.

The coefficients for a gaussian are organized such that the color channel is the inner (faster varying) axis, and the coefficient is the outer (slower varying) axis, i.e., for degree 1, the order of the 9 values is:
sh1n1_r, sh1n1_g, sh1n1_b, sh10_r, sh10_g, sh10_b, sh1p1_r, sh1p1_g, sh1p1_b

Each coefficient may be represented as an 8-bit signed integer. Additional quantization can be performed to attain a higher compression ratio. This library currently uses 5 bits of precision for degree 0 and 4 bits of precision for degrees 1 and 2, but this may be changed in the future without breaking backwards compatibility.

G-PCC can be used to encode arbitrary attributes. An extension of G-PCC for coding Gaussian Splats requires a simple modification to code quaternions and add the required metadata for pre- and post-processing attributes.

The current extension of G-PCC for Gaussian Splats is using following notations:
geometry: xyz positions of points
sh0: DC values of the spherical harmonics
sh1: first 3 AC values of the spherical harmonics
sh2: next 5 AC values of the spherical harmonics
sh3: last 7 AC values of the spherical harmonics
opacity: opacity
scale: scale
rotation: rotation

Table 1 below shows G-PCC extension bit allocation per component or attribute for a single primitive:

TABLE 1

| component | # of bits | |
|---|---|---|
| geometry | 3 × 18 | bits |
| sh0 | 3 × 12 | bits |
| sh1 | 3 × 12 | bits |
| sh2 | 5 × 12 | bits |
| sh3 | 7 × 0 | bits |
| opacity | 1 × 12 | bits |
| scale | 3 × 12 | bits |
| rotation | 4 × 12 | bits |
| TOTAL: | 282 | bits |

A pre-processing step is performed to quantize components with specific bitdepths that are reported in Table 1.

G-PCC may be used to encode positions as point clouds and the additional Gaussian splat attributes may be encoded with (Region-Adaptive Hierarchical Transform) RAHT.

### V3C—V3C Bitstream

V3C bitstream is a sequence of bits that forms the representation of coded volumetric frames and the associated data generating one or more coded V3C sequences (CVS). CVS is a sequence of bits identified and separated by appropriate delimiters, and is required to start with a VPS. CVS includes a V3C unit, and contains one or more V3C units with atlas sub-bitstream or video sub-bitstream. Video sub-bitstreams and atlas sub-bitstreams can be referred to as V3C sub-bitstreams. V3C unit header in conjunction with VPS information identifies which V3C sub-bitstream a V3C unit contains and how it is interpreted

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

In order to describe the present embodiment with respect of bitstream signaling, the similar terminology for encoding syntax as in ISO/IEC 23090-5 with for example:
u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with the most significant bit written first. When n is equal to 0, the associated syntax element is not present in the bitstream and its corresponding value shall be inferred to be equal to 0 unless specified otherwise in the semantics.
ue(v): unsigned integer 0-th order Exp-Golomb-coded syntax element with the left bit first.

While for many types of multimedia data (e.g., images, videos, point clouds, etc.) the output of a coding procedure needs to be ideally as close as possible to the original. However, when considering 3D scene representations this is not always the case. The reason for that is that what matters is not the media representation itself but how it looks once it is projected on an image plane through rendering. This means that there are multiple different combinations of scene representations that might lead to the same rendering. As a matter of fact, finding a representation of a scene from multiview images is an ill-posed problem because there are multiple solutions. For this reason, the actual information content of the scene is important during coding, and not the specific instance of the learned representation. This makes it possible to disentangle the two into scene-specific information and instance specific information. Current codecs such as G-PCC and SPZ are currently trying to code a representation that is as close as possible to one that was provided as input. However, this implies that a lot of instance specific information needs to be encoded along with the scene specific information. Therefore, trying to reduce as much as possible the instance specific information can help reaching lower rates while maintaining a comparable rendering quality.

In order to estimate a 3D scene from a set of images, there are multiple different ways to set a group of primitives to produce a similar rendering across all views. For this reason, encoding exactly the representation provided to the encoder is inefficient as it requires encoding the scene information plus the information required to decode the exact instance of the learned representation.

With instance specific information it is not only meant that a different type of primitive could be decoded (e.g., the encoder gets 3DGS as input and outputs billboards) but even that the same type of primitives, but with different parameters might lead to a very similar rendering. The decoded primitive type, and especially the specific parameters instantiations of the primitives do not matter as long as the codec requirements are met and the rendered fidelity is high.

Reducing the instance specific component is thus an effective way to code a 3D representation of a scene more efficiently. Thus, the present embodiments propose using an instance-agnostic representation of the scene that mostly contains information on the content of the scene and less instance-related information. Given this representation of the scene, the decoder may then estimate a possible set of primitives that may be later adjusted through residual information encoded in the bitstream.

The encoder may carry out the same prediction procedure that is carried out by the decoder, whereupon the encoder can optimize it's predictions based on the ground truth representation which allows the encoder to compute the aforementioned residual information. This is possible because the encoder contains the decoder (with a similar philosophy as video coding standards reference software implementations) and can simulate the decoder's behavior to compute residuals.

The present embodiments relate to an encoder and a decoder, that are capable of finding meaningful primitive and effectively computing their new attributes. In addition, the encoder according to an embodiment is capable of coding in or along the bitstream metadata needed to decode and reconstruct the volumetric representation from the instance-agnostic scene information. In addition, the decoder is capable of decoding and reconstruing the new volumetric representation from an instance-agnostic scene information being signaled and encoded in the received bitstream. The phrase along the bitstream (e.g., indicating along the bitstream) may be defined to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream. For example, an indication along the bitstream may refer to metadata in a container file that encapsulates the bitstream.

Before going into the detailed description of the present embodiments, some of the terms are defined. “Primitive” in media presentation refers to a collection of points that is used for rendering purposes. Therefore, a primitive in the context of the present embodiments can be a Gaussian splat, a spherical point, an ellipsoid, a billboard, a 2DGS. In addition to the examples given here, in future solutions there can be other elements to be considered as “primitives”. Therefore, the given examples should not be considered as the only examples. Another term for a primitive is a “rendering primitive” or a “representation primitive” being a geometric object that can be used for rendering and is characterized by a position in a N-dimensional space, possibly with some additional geometric attributes (e.g., the scales and the rotations for an ellipsoid or a gaussian, or the dimensions and rotation of a rectangle, cube, plane, hypercube, etc.) and possibly with some additional attributes (e.g., color, representation learned through gradient descent or a neural network, semantic information, material information, etc.) that will be referred to as non-geometric or appearance attributes. One example of a representation primitive is a 3D Gaussian splat. “Children primitive” and “Parents primitive” define a hierarchical relationship between primitives where a parent is obtained by aggregating the information of the children. The parent could be the same or a different type of primitive with respect to the children and it might have different attributes.

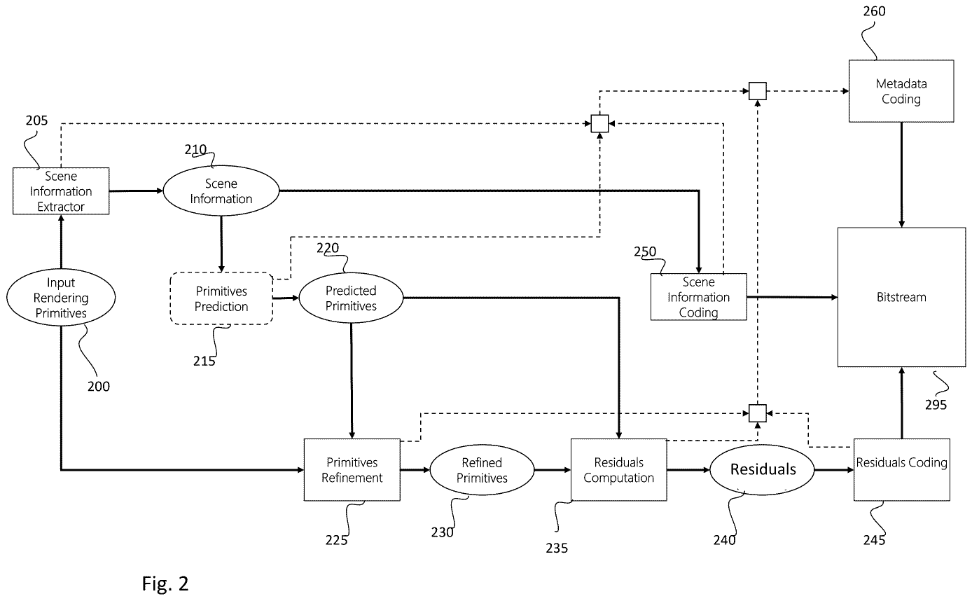

An encoder according to an embodiment is illustrated in FIG. 2. In general, the encoder receives as input a set of representation primitives 200 and the required encoding parameters: The encoder may optionally also receive a set of camera parameters. The optional set of camera parameters may originate from an optimization procedure or might have been found with another strategy or may be known from the acquisition procedure. The output of the encoder is an encoded bitstream 295. The method according to an embodiment carried out by the encoder comprise the following
i) receiving a set of representation primitives 200 as inputs (later referred to as “input primitives”);
ii) deriving general information about the scene 210, independent from the specific instance of the representation primitives;
iii) encoding 250 the scene information;
iv) using the scene information 210 to predict a set of primitives thus resulting “predicted primitives” 220;
v) optionally performing a refinement 225 of the predicted primitives 220 based on the input primitives 200 and optionally the camera parameters to produce refined primitives 230. This is needed to adjust the predicted primitives 220 to look, when rendered, as similar as possible to the input primitives 200 when rendered since the primitives prediction module 215 does not guarantee it;
vi) optionally computing 215 the residuals 240 between the refined primitives 230 and the predicted primitives 220;
vii) encoding 245 the residuals when computed; and
viii) encoding in or along the bitstream 295 metadata 260 describing the encoding process (such as prediction and scene information) that is necessary for the decoding and reconstruction at the decoder side.

In the above process for the encoder, steps v), vi), and vii) have been indicated to be optional. This means that the encoder produces a workable solution without them. However, each of the steps v), vi), and vii), individual or in combination, will improve the coding quality and results when performed by the encoder.

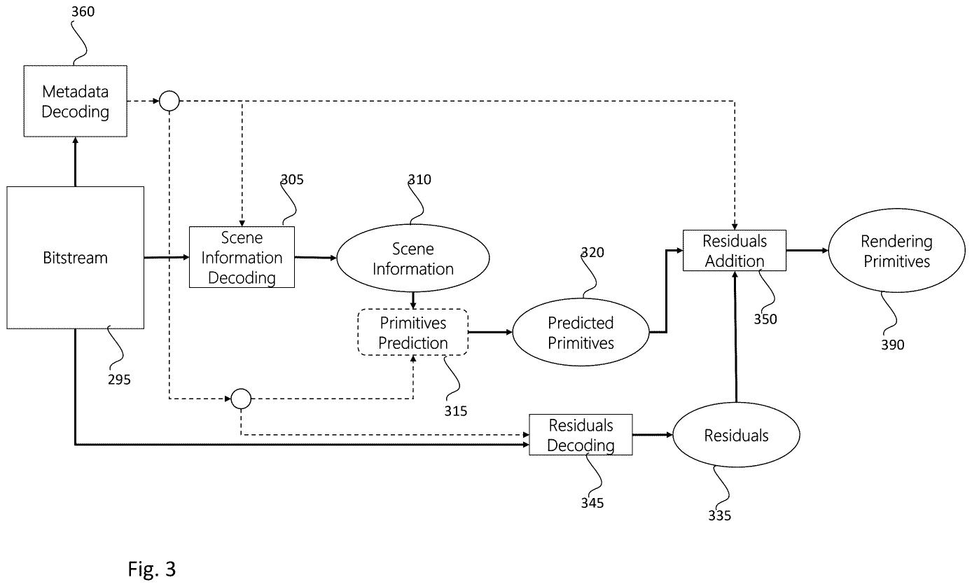

A decoder according to an embodiment is illustrated in FIG. 3. In general, the decoder gets as input an encoded bitstream 295 and outputs the decoded primitives 395 as well as metadata 310 specifying the primitives type and other useful information. The method according to an embodiment carried out by the decoder comprises the following:
i) decoding and extracting metadata 360 from the encoded bitstream 295, wherein metadata concerns at least a prediction and scene information;
ii) extracting and decoding scene information 310;
iii) using the decoded scene information 310 and the metadata 360 to predict a set of primitives thus resulting “predicted primitives” 320;
iv) optionally extracting and decoding residuals 335 from the encoded bitstream 295; and
v) when the residuals 335 have been decoded, the residuals 335 and the predicted primitives 320 are integrated to produce representation primitives 390. Otherwise, the predicted primitives 320 are used as representation primitives. It is to be noticed that some of the representation primitives may be different to the original ones but lead to comparable rendered scenes.

In the above process for the decoder, step iv) has been indicated to be optional. This means that the decoder produces a workable solution without decoding the residuals. However, using residuals together with the predicted primitives in order to produce representation primitives will improve the decoding result.

In the following, several operations of the encoder (of FIG. 2) according to an embodiment are discussed in more detailed manner. These operations include scene information extraction; primitives prediction; primitives refinement; residuals computation; scene information coding and residuals coding performed by a corresponding module.

### Receiving a Set of Representation Primitives (Step i) of the Encoding Process)

The set of representation primitives 200 are received by an input module of the encoder. The set of representation primitives can be one or more Gaussian splats, one or more spherical point clouds, one or more ellipsoids, one or more billboards, one or more 2DGS's. The representation primitives are received from an image source or a video source. The image/video source can be considered in this respect as a general term for covering all the modules and hardware needed to create a representation primitive from a frame of a visual volumetric content. This means that the image source may cover cameras needed to capture visual volumetric content; object recognition tools; classification models; feature extraction operations, etc.

### Scene Information Extraction (Step ii) of the Encoding Process)

Extracting scene information is carried out by a scene information extractor module 205 of the encoder. The scene information extractor module 205 is configured to extract a representation of the scene that is as independent as possible from the specific instances of the primitives 220. Thus, the scene information 210 concentrates on what is shown by the set of primitives (e.g., a circle), and not how it is shown (e.g., by a gaussian splat or several gaussian splats), the latter being the instance specific information. The scene information extractor module 205 receives as inputs coding parameters specifying how to carry out the information extraction, and outputs the scene information 210 which is instance-agnostic and metadata 260 that explains the nature of the scene information needed at the decoder side to decode it.

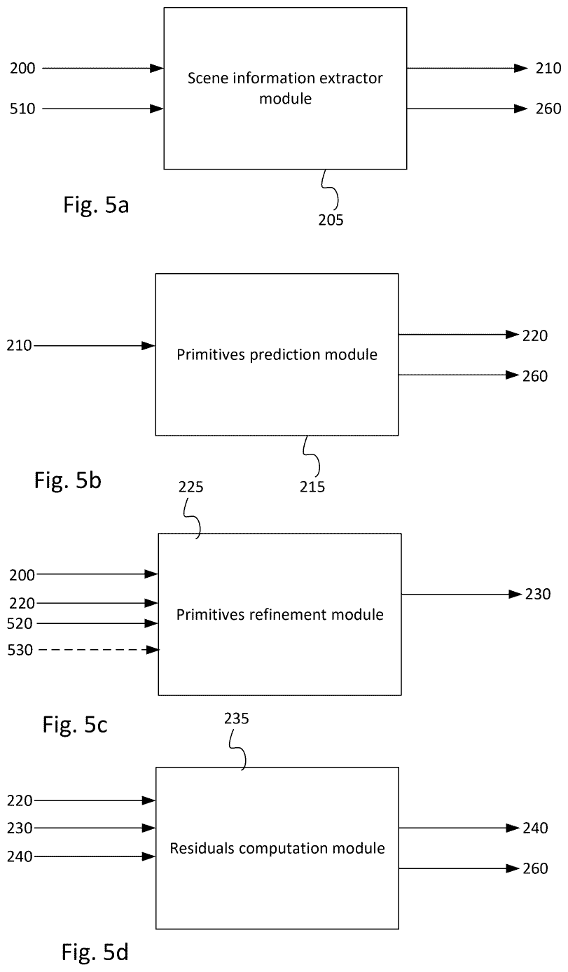

Scene information extractor module 205 is also illustrated in FIG. 5a showing the inputs, i.e. coding parameters 510 and the set of representation primitives 200, and showing the output, i.e., scene information 210 and metadata 260.

Scene information extraction method can be one of the following and can be indicated in a bitstream 260: Neural autoencoder, hierarchical aggregation, or probabilistic hierarchy. It is appreciated that these are examples of possible scene information extraction methods, and should not be considered as the only examples. These method are discussed next.

According to an embodiment, an option to extract scene information may be an autoencoder being trained in an unsupervised manner to get the primitives as input, to represent them with a latent representation and to predict a new set of primitives. The autoencoder can be based on a neural network that takes the primitives input, represents them in a bottleneck and tries to reconstruct the primitives again. The bottleneck is the part of the autoencoder where the transformed representation reaches the minimum information capacity with respect to the input either because it is smaller in size and/or because an entropy regularization mechanism was implemented during training. A latent representation is generally defined as a representation obtained by transforming input data using a neural network. In the case of autoencoders, the representation produced in the bottleneck is generally the most relevant latent representation in the network.

The autoencoder can be implemented as a PointNet or with sparse convolutions or with Point Cloud Transformer layers (there are a variety of such autoencoders in the literature). During training, the network minimizes the rendering loss, computed with a differentiable renderer, of the predicted primitives with respect to some ground truth images. This shows that the considered autoencoder doesn't even need to predict the same types of primitives as the ones it receives as inputs as long as the visual fidelity is high.

Ideally the neural network of the autoencoder is trained with a contrastive loss where different learned representations of the same scene should lead to similar latent representations and representations of different scenes should produce different latent representations. By this, the network is allowed to learn a general representation of the scene that is not dependent on the input primitives. The general representation can be further optimized for coding using neural network based coding techniques such as a learned entropy model. The neural network encoder can then be used for the extraction of the scene information while the neural network decoder can be later used in the primitives prediction module. In this case the scene is thus represented as a set of latent coefficients produced by a neural network and optionally a set of coordinates specifying the positions of such coefficients in N-dimensional space.

According to an embodiment, the scene information 210 may be obtained by aggregating together sets of neighboring primitives (e.g., through KL-divergence minimization or with a simple average) by maintaining as much as possible their rendering appearance. This allows effectively reducing the information relative to the specific instance of input primitives 200 since there generally are an infinite amount of combinations of primitives that can lead to that specific aggregation. In this case the scene information is represented as a set of primitives specifying a lower LoD.

According to another embodiment, the scene information 210 is a probability distribution of the presence of samples in a given subpart of the parent “block” in the scene representation. A simple approach comprises representing a binary or scalar mask in the volume of the grid cell discretized at a given resolution. For example, the block can be the set of voxels covered by the octree node representing the parent primitive. One value can be coded for each of these voxels, or at some chosen and signaled resolution. This value read by the decoder indicates that a child may or should be sampled in the corresponding voxel.

Scene Information Coding (Step iii) of the Encoding Process)

Scene information coding is carried out by a scene information coding module 250 of the encoder. The scene information coding module 250 takes as input the scene information 210 and set of encoding parameters specifying the type of coding to be carried out. The scene information coding module 250 outputs the encoded scene information into a bitstream 295 and other metadata 260 describing the scene information coding process, and metadata that can help improve performance. Such metadata can be in a form of a table with the per-symbol probabilities.

According to an embodiment, the scene information is quantized and entropy coded with CABAC

According to an embodiment, per-symbol frequencies may be computed from the scene information coefficients and used to estimate the empirical probabilities of the symbols. These may then be used by an arithmetic codec or by a Huffmann encoding procedure.

According to an embodiment, a learned entropy model is used to entropy code the scene information through an arithmetic codec.

### Primitives Prediction (Step iv) of the Encoding Process)

Prediction of the primitives is carried out by a primitives prediction module 215 of the encoder. The primitives prediction module 215 is configured to predict meaningful primitives based on the scene information, i.e., the instance agnostic scene representation. The primitives prediction module 215 takes as inputs the scene information 210, and outputs the predicted representation primitives 220 and metadata 260 useful for the prediction of the representation primitives at the decoder side.

Primitives prediction module 215 is also illustrated in FIG. 5b showing the inputs, i.e. scene information 210, and showing the output, i.e., predicted representation primitives 220 and metadata 260.

According to an embodiment, the primitives may be predicted by using a neural network-based decoder described in the previous section (i.e., scene information extraction step ii)), and the metadata may contain for example the number of points to be decoded for optimal reconstruction quality.

According to an embodiment, a set of plausible positions for the predicted primitives can be obtained by considering the geometry of the parent primitive (i.e., the primitive that covers the predicted primitive) and the other attributes obtained afterwards.

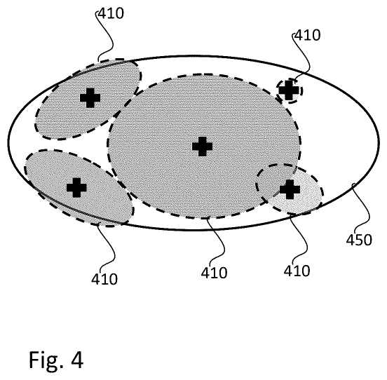

According to an embodiment, a number of primitives similar to the one in the original representation may be sampled from the geometry of the parent primitive to maximize the coverage. This is illustrated in FIG. 4 showing an example of sampled gaussians 410 (each having a center marked with “+”) to uniformly cover the parent gaussian 450.

When considering for example gaussian splatting, the primitives' positions can be obtained by sampling from the probability distribution of the parent primitives. Alternatively, the primitives' positions can be placed at similar distances to each other to fill the space in the ellipsoid within 3σ from the center.

According to one example, given the centers, the appearance attributes could be set to be equal to those of the parent primitives while the covariance matrix can be obtained from that of the parent. This is because, if—for example—the parent is obtained to minimize the KL-divergence with respect to the gaussian mixture of the children, then:

$${\sum }^{p} = {\sum }_{k = 1}^{K} {w}_{k} ( {\sum }_{k} + ( {μ}_{k} - {\hat{μ}}^{p} ) {( {μ}_{k} - {\hat{μ}}^{p} )}^{T} )$$

where Σ^{p} is the covariance of the parent, wₖ are the weights of the components of the mixture which in this case can be considered to be all equal \hat{μ}^{p} is the quantized position of the parent and Σₖ, μₖ are the covariance and position of the children.

It is possible to see that at this point, factors μₖ, wₖ, Σ^{p}, \hat{μ}^{p} are known, whereupon assuming identical covariance matrices it is possible to find a starting guess for Σₖ.

The optimal number of sampled/obtained children may be added to the metadata if it cannot be easily obtained, for example, from the scene information.

It is appreciated that the examples given above are discussed to provide understanding of possible alternatives. However, other techniques can be used instead.

### Primitives Refinement (Step v) of the Encoding Process)

Primitives refinement may be carried out by primitives refinement module 225 of the encoder. The primitives refinement module 225 takes as input the predicted primitives 220, the input representation primitives 200, coding parameters that specify how the refinement should be carried out and what the maximum allowed change for the values is, and optionally also camera parameters if available. The primitives refinement module 225 outputs the refined primitives 230.

Primitives refinement module 225 is also illustrated in FIG. 5c showing the inputs, i.e., predicted primitives 220, input representation primitives 200, coding parameters 520 and optionally camera parameters 530, and an output, i.e., the refined primitives 230 and metadata 260 useful for the decoder.

According to an embodiment, the camera parameters are available either from the optimization procedure or they can be determined with a different strategy. The camera parameters can be used to render the input representation primitives 200 and the predicted primitives 220. The predicted primitives 220 can then be optimized through gradient descent to make sure that the image they render is as similar as possible to the one obtained from the input primitive.

According to an embodiment, the predicted primitives' attributes can be refined by fixing one or more of their attributes (e.g., the position) and by applying recoloring such as in G-PCC. In this case, regarding a predicted primitive, its neighbors in the input representation primitives 200 can be found and its attribute can be obtained by interpolating the attributes of the neighbors.

In one embodiment a neural network could be used to predict the attributes of the predicted primitives given their position and the input representation primitives 200. The network can be implemented with a point transformer architecture and it may be trained beforehand to optimize the rendering loss between the input representation primitives 200 and the output refined primitives 230.

### Residuals Computation (Step vi) of the Encoding Process)

Computation of residuals may be carried out by a residuals computation module 235 of the encoder. To implement that, the residuals computation module 235 takes as input the refined primitives 230, the predicted primitives 220 and coding parameters that specify what type of residuals should be computed. The residuals computation module 235 is configured to output the residuals 240 between the refined primitives and the predicted primitives and other metadata 260 describing the residuals computation process.

Residuals computation module 235 is also illustrated in FIG. 5d showing the inputs, i.e., predicted primitives 220, refined primitives 230, coding parameters 540, and an output, i.e., the residuals 240 and metadata 260 useful for the decoder.

According to an embodiment, the residuals computation module 235 is configured to compute the residuals as the difference between the predicted primitives 220 and the refined primitives 230.

According to an embodiment, the residuals computation module 235 is configured to optimize a neural implicit representation that takes as input the predicted primitives 220 and tries to output the refined primitives. By this, the residual information between the primitives can be implicitly represented.

Residuals Coding (Step vii) of the Encoding Process)

When residuals have been computed, the residuals may be coded by a residuals coding module 245 of the encoder. In that case, the residuals coding module 245 takes as input the outputs 240 of the residuals computation module 235, and a set of encoding parameters specifying the type of coding to be carried out. The residuals coding module 245 outputs the encoded residuals into a bitstream 295 and other metadata 260 describing the residuals coding process, and metadata that can help improve performance. Such metadata can be in the form of a table with the per-symbol probabilities

According to an embodiment, the residuals may be quantized and entropy coded with CABAC

According to an embodiment, the per-symbol frequencies may be computed from the residuals and used to estimate the empirical probabilities of the symbols. These may then be used by an arithmetic codec or by a Huffmann encoding procedure.

According to an embodiment where an implicit representation of the residuals is learned, ISO/IEC15938-17 can be used to encode the MLP or any neural network coding technique.

In the following, several operations of the decoder (of FIG. 3) according to an embodiment are discussed in more detailed manner. These operations include parents decoding; relative positional information decoding; children global position recovery; geometric attributes decoding; and appearance attributes decoding performed by a corresponding module.

### Scene Information Decoding (Step ii) of the Decoding Process)

Decoding of scene information is carried out by a scene information decoding module 305 of the decoder. The scene information decoding module 305 takes as input the bitstream 295 relative to the scene information and some metadata 360 describing the scene information coding process, and metadata that can improve performance. Example of the latter may be a table with the per-symbol probabilities. The scene information decoding module 305 outputs the decoded scene information 310.

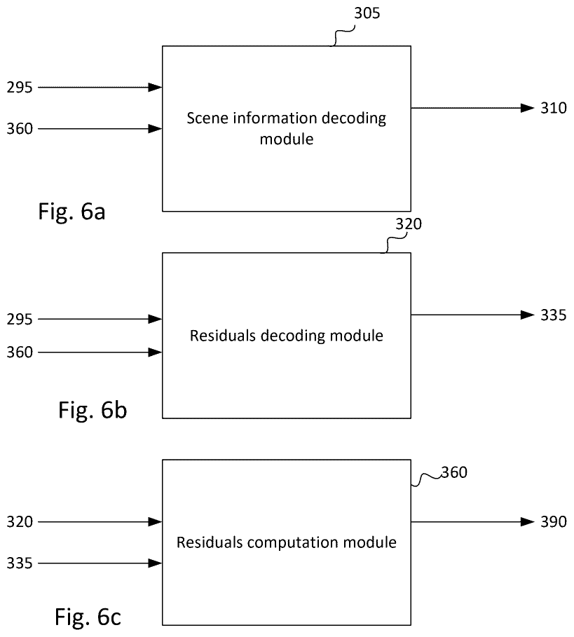

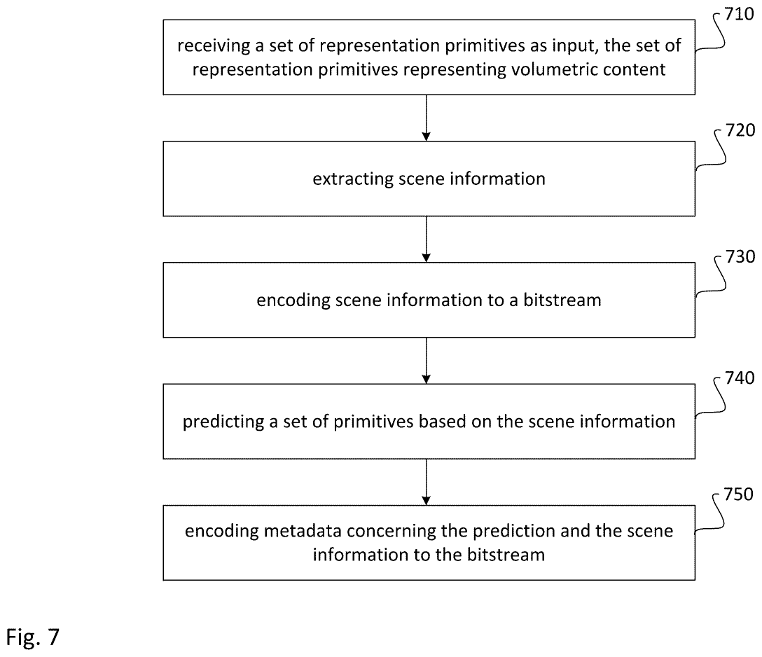

The scene information decoding module 305 is also illustrated in FIG. 6a showing the inputs, i.e., the bitstream 295 and metadata 360, and an output, i.e., the decoded scene information 310.

According to an embodiment, the scene information coefficients may be entropy decoded with CABAC and dequantized.

According to an embodiment, the per-symbol frequencies may be used to initialize the entropy decoder, which is then used to decode the quantized scene information. The entropy decoder can be an arithmetic decoder or a Huffman decoder. The scene information coefficients may then be dequantized.

According to an embodiment, the learned entropy model may be used with arithmetic decoding to entropy decode the scene information.

Primitives Prediction (Step iii) of the Decoding Process)

Prediction of the primitives is carried out by a primitives prediction module 315 of the decoder. The primitives prediction module 315 is configured to predict the primitives based on the decoded scene information 310. The primitives prediction module 315 takes as inputs the scene information 310, and outputs the predicted primitives 320.

### Residuals Decoding (Step iv) of the Decoding Process)

If the received bitstream comprises residuals, these residuals may be decoded by the residuals decoding module 345 of the decoder. The residuals decoding module 345 takes as input the bitstream 295 relative to the residuals and some metadata 360 describing the residuals coding process, and metadata that can improve performance. Example of the latter may be a table with the per-symbol probabilities. The residuals decoding module 345 outputs the decoded residuals 335.

The residuals decoding module 345 is also illustrated in FIG. 6b showing the inputs, i.e., the bitstream 295 and metadata 360, and an output, i.e., the decoded residuals 335.

According to an embodiment, the residuals may be entropy decoded with CABAC and dequantized

According to an embodiment, the per-symbol frequencies may be used to initialize the entropy decoder, which is then used to decode the quantized residuals. The entropy decoder can be an arithmetic decoder or a Huffman decoder. The residuals may then be dequantized.

### Residuals Addition (Step v) of the Decoding Process)

After having decoded the residuals, the decoder may add the residuals to the predicted primitives using the residuals computation module 360 of the decoder. The residuals computation module 360 takes as input the predicted primitives 320 and the residuals 335, and metadata specifying how these two components should be added together. The residuals computation module 350 outputs the decoded representation primitives 390.

The residuals computation module 360 is also illustrated in FIG. 6c showing the inputs, i.e., the predicted primitives 320 and the residuals 335, and an output, i.e., the decoded representation primitives 390.

According to an embodiment, the representation primitives 390 may be obtained by adding the residuals 335 to the predicted primitives 320.

According to an embodiment, the representation primitives 390 may be obtained by feeding to the implicit representation the predicted primitives 320.

In the following signalling according to embodiments is discussed.

According to an embodiment, the type of primitive may be signaled in the metadata to be encoded into or extracted from bitstream. Table 2 below lists the primitive types.

TABLE 2

| primitive_type Index | Primitive type |
|---|---|
| 0 | 3D Gaussian Splat |
| 1 | 2D Gaussian Splat |
| 2 | Ellipsoids |
| 3 | Spheres |
| 4 | Billboards/Planes |
| 5 | Convex shapes |
| 6 | Generalized Gaussians |
| 7 . . . 15 | RESERVED |

According to an embodiment, the type of attributes may be signaled for the primitive. Table 3 below lists attribute types.

TABLE 3

| Attribute | | |
|---|---|---|
| types index | Identifier | Attribute type |
| 0 | ATTR_POSITION | Position |
| 1 | ATTR_ROTATION | Rotation |
| 2 | ATTR_SCALE | Scale |
| 3 | ATTR_BOX | Box |
| 4 | ATTR_RADIUS | Radius |
| 5 | ATTR_COLOR | Color |
| 6 | ATTR_OPACITY | Opacity |
| 7 | ATTR_SPHERICAL_HARMONICS_BAND_1 | Spherical Harmonics Band 1 |
| 8 | ATTR_SPHERICAL_HARMONICS_BAND_2 | Spherical Harmonics Band 2 |
| 9 | ATTR_SPHERICAL_HARMONICS_BAND_3 | Spherical Harmonics Band 3 |
| 10 . . . 14 | ATTR_RESERVED | Reserved |
| 15 | ATTR_UNSPECIFIED | Unspecified |

According to an embodiment, the scene information extraction may be signaled as detailed in the Table 4 below.

TABLE 4

| Scene information | |
|---|---|
| extraction index | Scene information extraction method |
| 0 | NEURAL_AUTOENCODER |
| 1 | HIERARCHICAL_AGGREGATION |
| 2 | PROBABILISTIC_HIERARCHY |
| 3 . . . 8 | RESERVED |

According to an embodiment, the residual type index may be signaled as detailed in the Table 5 below.

TABLE 5

| Residual type index | Residual type |
|---|---|
| 0 | ORIGINAL_PREDICTED_DIFFERENCE |
| 1 | IMPLICIT_REPRESENTATION |
| 2 . . . 3 | RESERVED |

According to an embodiment, the possible set of implicit representation codecs types may be signaled as detailed in the Table 6 below.

TABLE 6

| Implicit representation codec index | Implicit representation codec type |
|---|---|
| 0 | NNC |
| 1,, 8 | RESERVED |

According to an embodiment, metadata describing how the residual data is represented and encoded is shown in Table 7 below.

TABLE 7

| | |
|---|---|
| residual_type | u(2) |
| if (residual_type == ORIGINAL_PREDICTED_DIFFERENCE){ | |
| quantization_step | u(8) |
| } else { | |
| implicit_representation_codec_id | u(3) |
| } | |

The following syntax is used in Table 7:

residual_type: this defines how the residual information is represented and it tells the decoder what procedure to follow to integrate this information with the predictions. The possible residual types are explained in Table 4.

quantization_step: this defines the quantization step for the residuals if they are of the type ORIGINAL_PREDICTED_DIFFERENCE

implicit_representation_codec_id: specifies the codec used for coding the implicit representation. The possible codecs are specified in Table 5.

According to an embodiment, metadata required to predict the same predicted primitives is shown in Table 7 below.

TABLE 7

| | |
|---|---|
| information_extraction_type | u(2) |
| predicted_primitives_type | u(4) |
| If (information_extraction_type == | |
| HIERARCHICAL_AGGREGATION){ | |
| num_parents | u(32) |
| for (i=0; i<num_parents; i++){ | |
| num_predicted_children[i] | u(16) |
| } | |
| else if (information_extraction_type == | |
| NEURAL_AUTOENCODER){ | |
| num_predicted_primitives | u(32) |
| } | |

For what concerns the scene information metadata that depends on the chosen codec for the metadata itself. For example, if the scene specific information is a lower LoD representation of the primitives then the metadata would be the metadata of the codec used to encode the representation at that LoD (e.g. for gaussians it could be the metadata of SPZ).

The following syntax is used in Table 7:

information_extraction_type: defines how the scene-specific information was extracted. Some possibilities are defined in Table 3.

predicted_primitives_type: specifies what types of primitives the decoder should predict with the primitives prediction module, A set of possible primitives is defined in Table 1.

num_parents: if the scene-specific information is obtained by representing a region in space with a parent primitive then this specifies the number of parents that cover the whole scene.

num_predicted_children: if the scene-specific information is obtained by representing a region in space with a parent primitive this specifies the number of children that should be predicted starting from the parent representation.

num_predicted_primitives: if the scene specific information is obtained with an autoencoder then this specifies how many primitives should be generated with the decoder.

FIG. 7 is a flowchart illustrating a method for encoding according to an embodiment. The method shown in FIG. 7 comprises receiving 710 a set of representation primitives as input, the set of representation primitives representing volumetric content; extracting 720 scene information; encoding 730 the scene information to a bitstream; predicting 740 a set of primitives based on the scene information; and encoding 750 metadata concerning the prediction and the scene information to the bitstream. The steps of the method as shown in FIG. 7 can be implemented with a respective computer module of a computer system.

An apparatus according to an embodiment comprises means for implementing the method of FIG. 7 and other embodiments. Therefore, the apparatus comprises at least means for receiving a set of representation primitives as input, the set of representation primitives representing volumetric content; means for extracting scene information; means for encoding the scene information to a bitstream; means for predicting a set of primitives based on the scene information; and means for encoding metadata concerning the prediction to the bitstream. The means of the apparatus may comprise one or more processors, a memory storing a computer program having computer readable instructions to implement the method.

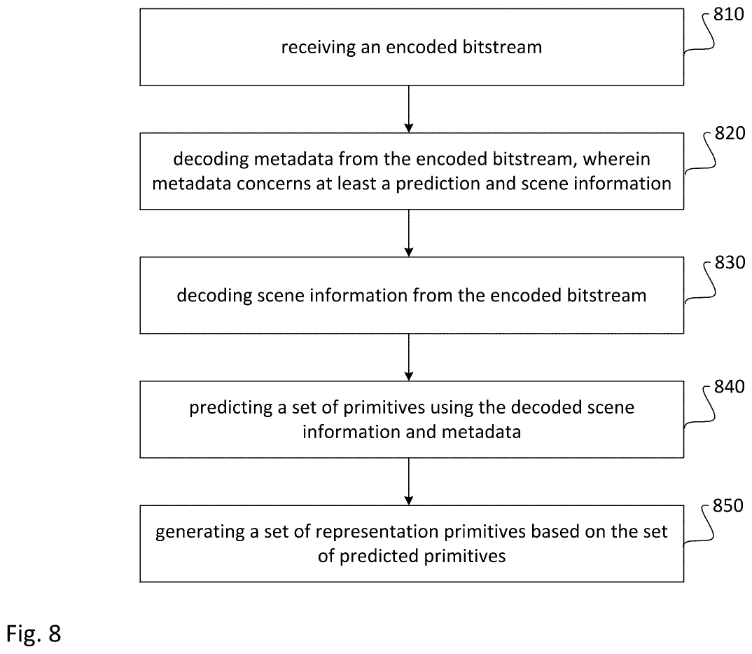

FIG. 8 is a flowchart illustrating a method for decoding according to an embodiment. The method shown in FIG. 8 comprises receiving 810 an encoded bitstream; decoding 820 metadata from the encoded bitstream, wherein metadata concerns at least a prediction and scene information; decoding 830 scene information from the encoded bitstream; predicting 840 a set of primitives using the decoded scene information and metadata; and generating 850 a set of representation primitives based on the set of predicted primitives. The steps of the method as shown in FIG. 8 can be implemented with a respective computer module of a computer system.

An apparatus according to an embodiment comprises means for implementing the method of FIG. 8 and other embodiments. Therefore, the apparatus comprises at least means for receiving an encoded bitstream; means for decoding metadata from the encoded bitstream; means for decoding scene information from the encoded bitstream; means for predicting a set of primitives using the decoded scene information and metadata; and means for generating a set of representation primitives based on the set of predicted primitives. The means of the apparatus may comprise one or more processors, a memory storing a computer program having computer readable instructions to implement the method.

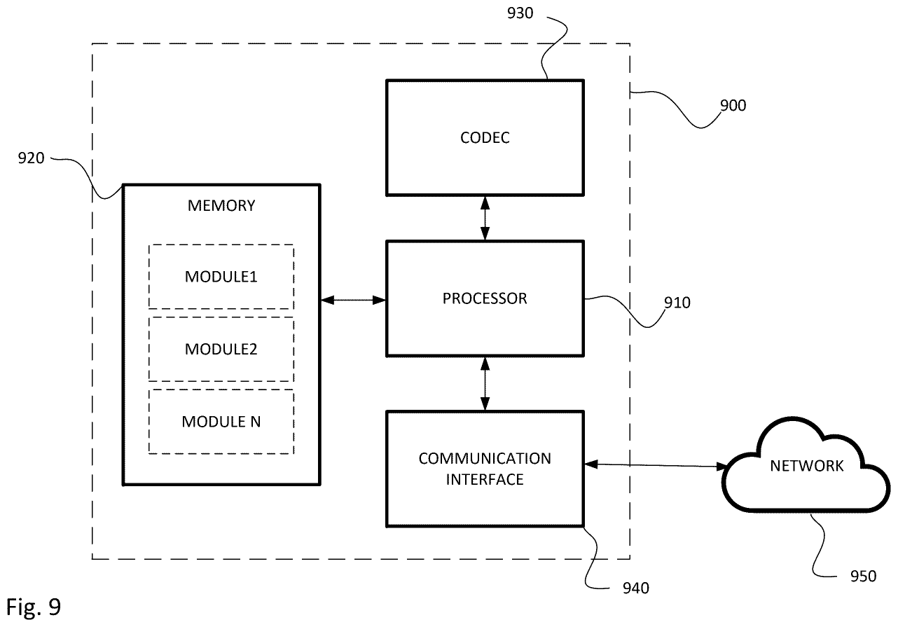

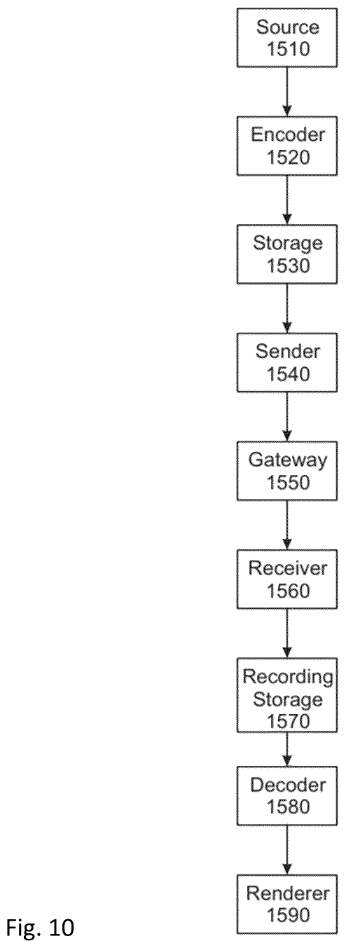

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 9. A computer-readable medium may comprise a computer-readable storage medium that may be any media or means that can contain or store the instructions for use by or in connection with an instruction execution system, apparatus, or device, such as a computer.

FIG. 9 illustrates an example of an electronic apparatus 900, being an example of video coding system where the present embodiments can be implemented. In some embodiments, the apparatus may be a mobile terminal or a user equipment of a wireless communication system or a camera device. The apparatus 900 may also be comprised at a local or a remote server or a graphic processing unit of a computer. The apparatus may also be comprised as part of a head-mounted display device.

The apparatus 900 comprises one or more processors 910 and one or more memories 920 and one or more transceivers interconnected through one or more buses. The one or more memories 920 store computer instructions, for example in respective modules (Module1, Module2, ModuleN). The one or more memories may store data in the form of image, video and/or audio data, and/or may also store instructions to be executed by the processors or the processor circuitry. The one or more processors may comprise a central processing unit (CPU) and/or a graphical processing unit (GPU). The one or more buses may be address, data or control buses, and may include interconnection mechanism, such as a series of lines on a motherboard or integrated circuit, fiber optics or other optical communication equipment. The apparatus also comprises a codec 930 that is configured to implement various embodiments relating to present solution. According to some embodiments, the apparatus may comprise an encoder or a decoder. The apparatus 900 also comprises a communication interface 940 which is suitable for generating wireless communication signals for example for communication with a cellular communications network, a wireless communications system, or a wireless local area network, and thus enabling data transfer over data transfer network 950.

The apparatus 900 may comprise a display in the form of a liquid crystal display. In other embodiments of the invention the display may be any suitable display technology suitable to display an image or video. The apparatus 900 may further comprise a keypad. In other embodiments of the invention any suitable data or user interface mechanism may be employed. For example, the user interface may be implemented as a virtual keyboard or data entry system as part of a touch-sensitive display. The apparatus 900 may comprise a microphone or any suitable audio input which may be a digital or analogue signal input. The apparatus 900 may further comprise an audio output device which in embodiments of the invention may be any one of: an earpiece, speaker, or an analogue audio or digital audio output connection. The apparatus 900 may also comprise a battery (or in other embodiments of the invention the device may be powered by any suitable mobile energy device such as solar cell, fuel cell or clockwork generator). The apparatus may further comprise a camera capable of recording or capturing images and/or video. The camera may be a multi-lens camera system having at least two camera sensors. The camera is capable of recording or detecting individual frames which are then passed to the codec 930 or to processor 910. The apparatus may receive the video and/or image data for processing from another device prior to transmission and/or storage.

The apparatus 900 may further comprise e.g., the other functional units disclosed e.g., in FIG. 1 for implementing any of the present embodiments.

The apparatus may operate in a system, comprising multiple communication devices, which can communicate through one or more networks. The system may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system can be a mobile telephone network enabling a connection to the internet. The connection can form, but is not limited to, long range wireless connections, short range wireless connections, and various wired connections including, but not limited to, telephone lines, cable lines, power lines, and similar communication pathways.

The example communication devices operating in the system may include, but are not limited to, an electronic device or apparatus, a combination of a personal digital assistant (PDA) and a mobile telephone, a PDA, an integrated messaging device (IMD), a desktop computer, a notebook computer, each of which can be a representative of the apparatus according to present embodiments. The apparatus according to present embodiments may be stationary or mobile when carried by an individual who is moving. The apparatus may also be located in a mode of transport including, but not limited to, a car, a truck, a taxi, a bus, a train, a boat, an airplane, a bicycle, a motorcycle, or any similar suitable mode of transport.

The apparatus may also be a set-top box; i.e. a digital TV receiver, which may/may not have a display or wireless capabilities, a tablet or (laptop) a personal computer (PC), which have hardware or software or combination of the encoder/decoder implementations, in various operating systems, or a chipset, processor, DSP and/or embedded system offering hardware/software based coding.

The apparatus according to present embodiments may send and receive calls and messages and communicate with service providers through a wireless connection to a base station. The base station may be connected to a network server that allows communication between the mobile telephone network and the internet.

The apparatus may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

FIG. 10 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be encoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random-access memory. The format of the coded media bitstream in the recording storage 2170 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g., for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1580 is discussed to simplify the description without a lack of generality.

The coded media bitstream may be processed further by a decoder 1580, whose output is one or more uncompressed media streams. Finally, a renderer 1590 may reproduce the uncompressed media streams with a loudspeaker or a display, for example. The receiver 1560, recording storage 1570, decoder 1580, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally, or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

A decoder 1580 may be configured to perform switching between different representations e.g., for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising: at least one processor; and at least one memory storing instructions that, when executed by the at least one processor, cause the apparatus to perform at least the following: receive a set of representation primitives as input, wherein the set of representation primitives representing volumetric content; extract scene information; encode the scene information to a bitstream; predict a set of primitives based on the scene information; and encode metadata concerning the prediction and the scene information to the bitstream.

2. The apparatus according to claim 1, wherein a representation primitive is one of the following: a Gaussian splat, a spherical point, an ellipsoid, a billboard.

3. The apparatus according to claim 1, wherein the extracted scene information is independent from instances of the representation primitives.

4. The apparatus according to claim 1, wherein the scene information is extracted using one of the following: neural autoencoder, hierarchical aggregation, or probabilistic hierarchy.

5. The apparatus according to claim 1, wherein the set of primitives is predicted by means of a neural network model or by sampling the set of primitives from their parent primitive.

6. The apparatus according to claim 1, further being caused to refine the predicted set of primitives, and to encode metadata concerning the refinement to the bitstream.

7. The apparatus according to claim 6, wherein the refinement results in refined primitives, wherein the metadata concerning the refinement comprises residuals between the refined primitives and the predicted primitives.

8. The apparatus according to claim 6, being further caused to use camera parameters for refining the predicted set of primitives.

9. The apparatus according to claim 1, further being caused to encode an identifier for a type of the representation primitive to metadata.

10. The apparatus according to claim 1, further being caused to encode an identifier for an attribute type of the representation primitive to metadata.

11. The apparatus according to claim 1, further being caused to encode an identifier for a scene information extractor to metadata.

12. The apparatus according to claim 1, further being caused to encode an identifier for a residual type to metadata.

13. An apparatus comprising: at least one processor; and at least one memory storing instructions that, when executed by the at least one processor, cause the apparatus to perform at least the following: receive an encoded bitstream; decode metadata from the encoded bitstream, wherein metadata concerns at least a prediction and scene information; decode scene information from the encoded bitstream; predict a set of primitives using the decoded scene information and metadata; and generate a set of representation primitives based on the set of predicted primitives.

14. The apparatus according to claim 13, further being caused to decode refinement information from the metadata and to refine the predicted set of primitives based on the refinement information.

15. The apparatus according to claim 14, wherein the refinement information comprises residuals, whereupon the apparatus is caused to integrate the residuals to the predicted primitives.

16. The apparatus according to claim 13, further being caused to decode an identifier for a type of the representation primitive from metadata.

17. The apparatus according to claim 13, further being caused to decode an identifier for an attribute type of the representation primitive from metadata.

18. The apparatus according to claim 13, further being caused to decode an identifier for a scene information extractor from metadata.

19. A method comprising: receiving an encoded bitstream; decoding metadata from the encoded bitstream, wherein metadata concerns at least a prediction and scene information; decoding scene information from the encoded bitstream; predicting a set of primitives using the decoded scene information and metadata; and generating a set of representation primitives based on the set of predicted primitives.
